(19) United States
(12) Patent Application Publication
(10) Pub. No.: US 2016/0003387 A1
(43) Pub. Date: Jan. 7, 2016

(54) FLUID FITTING

(71) Applicant: DAISEN Co., Ltd., Ota-shi (JP)

(72) Inventors: Hiroaki TAGUCHI, Ora-gun (JP); Toshiharu HORIKOSHI, Kiryu-shi (JP)

(73) Assignee: DAISEN CO., LTD., Ota-shi (JP)

(21) Appl. No.: 14/521,993

(22) Filed: Oct. 23, 2014

(30) Foreign Application Priority Data
Jul. 3, 2014 (JP) 2014-138008

(51) Int. Cl. F16L 27/08; F16L 21/00

(52) U.S. Cl. CPC F16L 27/0845; F16L 21/00

(57) ABSTRACT

A fluid fitting of an embodiment mainly includes: a first connecting part connected to a supply path through which compressed air is supplied; a second connecting part connected to a use path through which the compressed air is used; a rotary fitting body by which the first connecting part and the second connecting part are rotatably connected; and a third connecting part rotatably connected to the second connecting part. Further, the rotary fitting body is capable of rotating such that the first connecting part can bend at an angle of 90 degrees with respect to the second connecting part.

This application claims priority from Japanese Patent Application Number JP 2014-138008 filed on Jul. 3, 2014, the content of which is incorporated herein by reference in its entirety.

### BACKGROUND OF THE INVENTION

1. Field of the Invention

The present invention relates to a rotatable fluid fitting interposed between hoses connecting a fluid supply source such as a compressor and a fluid using device such as a nail gun.

2. Description of the Related Art

As a conventional technique, a rotatable fluid fitting is interposed between hoses serving as paths which compressed air to be supplied to a compressed-air using device passes through.

For example, in Japanese Patent Application Publication No. Hei 6-109176, a fitting employs balls to be capable of a rotary motion. Specifically, for a nipple body to be rotatably connected to a sleeve body, a front spherical surface formed on the nipple side is fitted in an inwardly spherically recessed portion of the fitting, so that these two parts are held together with a ball.

Moreover, Japanese Patent Application Publication No. Hei 9-170688 discloses a feature that involves rotating a spherical fitting part. Specifically, referring to FIG. 1, a sleeve body 1 and a nipple body 2 are joined to each other by a fitting body 3 formed of two divided parts. A pivot ring is formed in a divided part 4, which is one of the divided two, while a shaft is formed on the other divided part 5, so that the ring and the shaft serve as slide-fit parts. Moreover, the fitting is configured such that the axis of these slide-fit parts along which they are joined is inclined at a predetermined angle with respect to the longitudinal axis of the sleeve, thereby allowing the sleeve body 1 and the nipple body 2 to swing through wide angles. In this way, a nail gun or the like connected through the fitting body 3 can be used in an efficient manner.

However, in the invention described in Japanese Patent Application Publication No. Hei 6-109176 mentioned above, there are provided multiple rotatably connecting spots, which sometimes makes the connecting of a hose to the nipple body difficult.

Moreover, in Japanese Patent Application Publication No. Hei 9-170688, referring to FIG. 3 thereof, the nipple body 2 is inclined at an angle of 45 degrees with respect to the sleeve body 1 when the fitting body 3 is rotated. At this angle, however, the angle at which the hoses connected by the fitting body are bent is not large enough, which possibly hampers the workability in a tight space.

### SUMMARY OF THE INVENTION

The present invention has been made in view of the above problems, and an object of the present invention is to provide a fluid fitting which achieves improved usability thereof for the user by allowing hoses connected thereto to bend to a sufficient extent.

A fluid fitting of the present invention is a fluid fitting to be rotatably interposed between paths for connecting a fluid supply source and a fluid using device, including: a first connecting part disposed in such a way as to communicate with any one of the fluid supply source and the fluid using device; a second connecting part disposed in such a way as to communicate with the other of the fluid supply source and the fluid using device; and a rotary fitting body disposed between the first connecting part and the second connecting part and being capable of rotation, in which the rotary fitting body includes a first fitting part and a second fitting part rotatably joined to the first fitting part, a dividing surface by which the first fitting part and the second fitting part are divided rotatably is inclined at 45 degrees from an axial direction of the first fitting part and the second fitting part, and an outer periphery of the dividing surface has a circular shape.

### BRIEF DESCRIPTION OF THE DRAWINGS

FIGS. 1A and 1B are views showing a fluid fitting of the present invention, FIG. 1A being a view of the fluid fitting as seen from a lateral side, and FIG. 1B being a cross-sectional view thereof.

FIGS. 2A and 2B are views showing the fluid fitting of the present invention, FIG. 2A being a side view showing the constituent components of the fluid fitting disassembled, and FIG. 2B being a perspective view thereof.

FIGS. 3A and 3B are views showing the fluid fitting of the present invention, FIG. 3A being a view of the fluid fitting with connecting parts bent relative to each other, as seen from the lateral side, and FIG. 3B being a cross-sectional view thereof.

FIG. 4 is a view showing the fluid fitting of the present invention and is a partially enlarged cross-sectional view of a rotary fitting body.

FIG. 5 is a view showing the fluid fitting of the present invention and is a partially enlarged cross-sectional view of a rotary fitting body of another embodiment.

### DESCRIPTION OF THE INVENTION

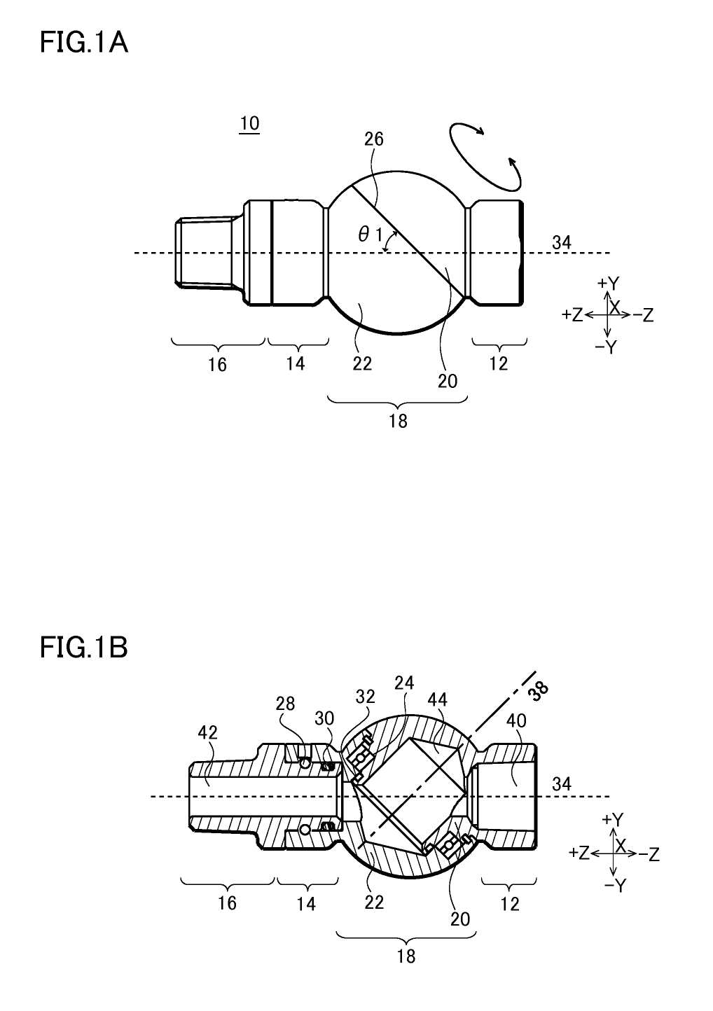

The configuration of a fluid fitting 10 according to an embodiment will be described with reference to FIGS. 1A and 1B. FIG. 1A is a side view of the fluid fitting 10 of this embodiment. FIG. 1B is a cross-sectional view of the fluid fitting 10 taken along the axis at the center thereof.

The following description will be given by using X, Y, and Z directions when appropriate. The X and Y directions each represent the radial direction of a pipe part of the fluid fitting 10, and the Z direction represents the axial direction of the pipe part of the fluid fitting. In the fluid fitting 10 of this embodiment, compressed air flows from the −Z side to the +Z side. This embodiment will describe a case where compressed air is employed as the fluid that flows through the fluid fitting 10, but a gas other than air or a liquid may instead be employed.

Referring to FIG. 1A, the fluid fitting 10 of this embodiment mainly includes: a first connecting part 12 configured to be connected to a supply path through which compressed air is supplied; a second connecting part 14 configured to be connected to a use path through which the compressed air is used; a rotary fitting body 18 by which the first connecting part 12 and the second connecting part 14 are rotatably connected; and a third connecting part 16 rotatably connected to the second connecting part 14.

The fluid fitting 10 essentially serves to connect hoses (paths) which connect a fluid supply source such as a compressor and a fluid using device such as a nail gun, by being interposed between these hoses, in such a way that the hoses can be rotated and bent.

The first connecting part 12 is a part to which a hose is to be connected through a plug not shown. The first connecting part 12 has a cylindrical shape having its center axis along the Z direction, and a thread groove is formed in the inner surface thereof. The plug is screwed in this thread groove while the fluid fitting 10 is in use.

The second connecting part 14 is a part to which a hose is to be connected through the third connecting part 16 on the opposite side from the first connecting part 12. Like the first connecting part 12, the second connecting part 14 also has a cylindrical shape having its center axis along the Z direction. A groove is formed on the inner side of the second connecting part 14 for it to be rotatably fitted to the third connecting part 16.

The rotary fitting body 18 is disposed between the first connecting part 12 and the second connecting part 14 and serves to couple the first connecting part 12 and the second connecting part 14 to each other rotatably. The rotary fitting body 18 is formed of a first fitting part 20 and a second fitting part 22 and has a substantially spherical shape as a whole. Here, the first fitting part 20 is a metallic body formed integrally with the first connecting part 12, while the second fitting part 22 is a metallic body formed integrally with the second connecting part 14. In this way, the number of components is reduced.

The first fitting part 20 and the second fitting part 22 forming the rotary fitting body 18 are bounded at a dividing surface 26. The dividing surface 26 is a circular surface defined on a flat plane, and an angle θ1 of inclination of the dividing surface 26 from an axial line 34 is 45 degrees. That the dividing surface 26 is a circular surface prevents part of the first fitting part 20 or the second fitting part 22 from coming out of the dividing surface 26 when the first fitting part 20 is rotated relative to the second fitting part 22. This feature will be described later. Here, the axial line 34 refers to the center line of each of the first connecting part 12 and the second connecting part 14 having cylindrical shapes.

The third connecting part 16 is a cylindrical part rotatably connected to an end portion of the second connecting part 14 on the +Z side, and an end portion of the third connecting part 16 on the +Z side has a plug shape having a thread ridge on the periphery thereof. While the fluid fitting 10 is in use, a socket is crewed to the end portion of the third connecting part 16 on +Z side, and a hose is connected through this socket. Moreover, since the third connecting part 16 and the second connecting part 14 are rotatably connected to each other, the hoses connected by the fluid fitting 10 are prevented from being twisted while the fluid fitting 10 is in use.

Referring to FIG. 1B, a first flow path 40 is formed inside the first connecting part 12, and a second flow path 42 is formed inside the second connecting part 14 and the third connecting part 16. The first flow path 40 and the second flow path 42 communicate with each other through an internal space 44 formed inside the rotary fitting body 18. While the fluid fitting 10 is in use, compressed air supplied from the compressor flows through the first flow path 40, the internal space 44, and the second flow path 42 in this order and is then fed to a nail gun or the like.

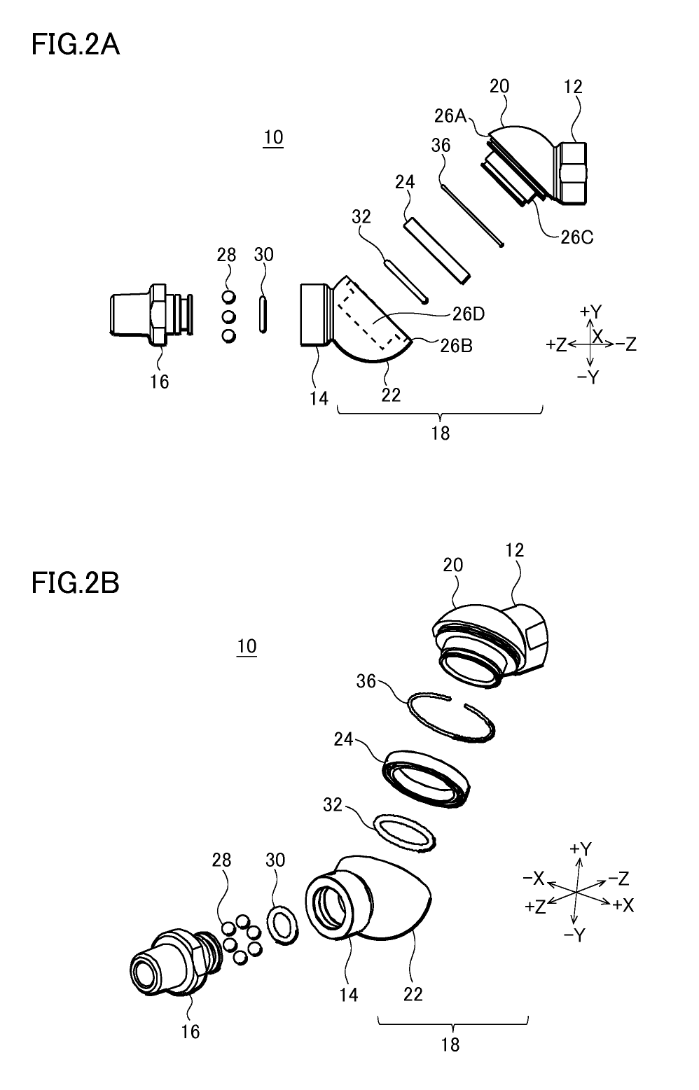

The above configuration of the fluid fitting will be described in detail with reference to FIGS. 2A and 2B. FIG. 2A is a side view showing the fluid fitting 10 disassembled. FIG. 2B is a perspective view thereof.

Inside the rotary fitting body 18, a bearing 24 is disposed between the first fitting part 20 and the second fitting part 22. Disposing the bearing 24 between these two parts smoothens the rotation of the first fitting part 20 and the second fitting part 22. Moreover, an O-ring 32 made of a resin material formed in an annular shape is disposed between the first fitting part 20 and the second fitting part 22, so that the airtightness of the internal space 44 is ensured. Furthermore, a C-pin 36 is a member disposed between the outer peripheral surface of the first fitting part 20 and the inner peripheral surface of the second fitting part 22, and configured to allow these two parts to be fitted to each other rotatably.

A dividing surface 26A having a circular shape at its outer periphery is formed on a portion of the first fitting part 20 which faces the second fitting part 22. Moreover, a dividing surface 26B is formed on a portion of the second fitting part 22 which faces the first fitting part 20. While the fluid fitting 10 is in use, the dividing surfaces of both fitting parts slide on each other to make a rotary motion.

Multiple steel balls 28 are disposed between the second connecting part 14 and the third connecting part 16 along the circumferential direction. The steel balls 28 are rotatably fitted in a groove provided and extended in the inner wall of the second connecting part 14 and in a groove provided and extended in the outer periphery of the third connecting part 16. Thus, the third connecting part 16 and the second connecting part 14 are rotatably connected by the steel balls 28. In addition, an O-ring 30 is disposed between the outer periphery of the third connecting part 16 and the inner periphery of the second connecting part 14, so that airtightness is ensured for the connecting spots of these two parts.

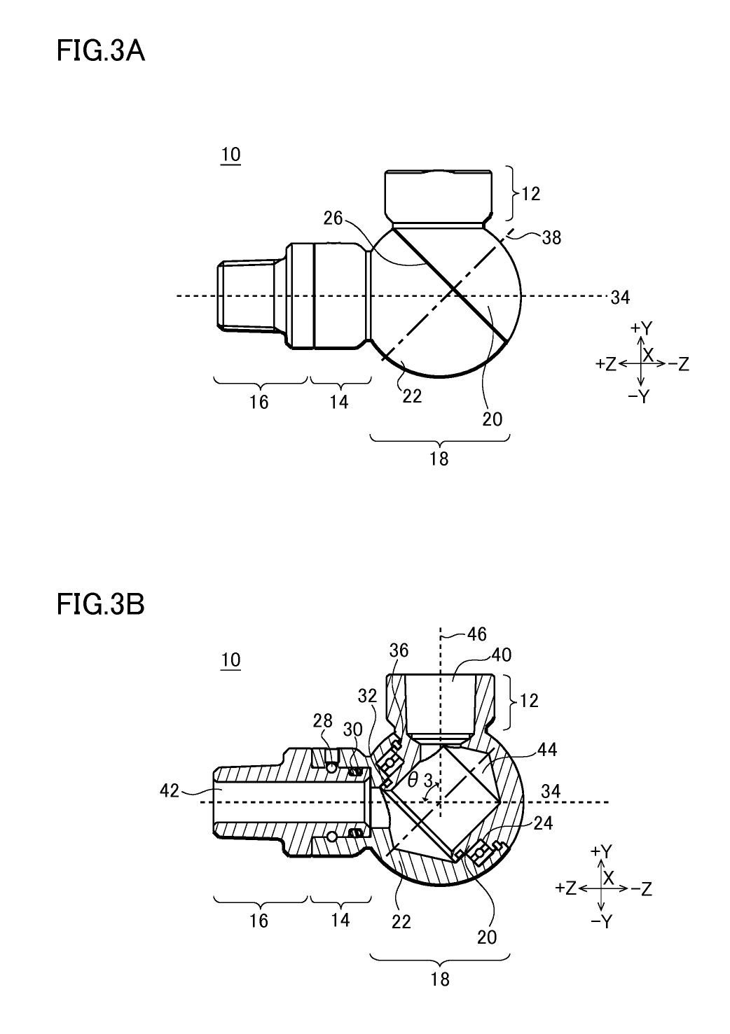

A state where the rotary fitting body 18 is rotated to make the first connecting part 12 face in the +Y direction will be described with reference to FIGS. 3A and 3B. FIG. 3A is a side view showing the fluid fitting 10 in this state. FIG. 3B is a cross-sectional view showing this state.

Referring to FIG. 3A, the first connecting part 12 is rotated by 180 degrees from the state shown in FIGS. 1A and 1B, so that the first connecting part 12 faces in the +Y direction. Specifically, the first fitting part 20 and the second fitting part 22 are slid relative to each other at the dividing surface 26 to rotate the first connecting part 12 by 180 degrees. In this step, the first connecting part 12 is rotated about a rotation axis 38 which extends at a right angle from the center of the dividing surface 26.

As described above, in this embodiment, the dividing surface 26 dividing the first fitting part 20 and the second fitting part 22 has a circular shape. Indeed, as shown in FIG. 2A, a protruding portion 26C of the first fitting part 20 protruding in a cylindrical shape is set in a recessed portion 26D of the second fitting part 22, and the dividing surface 26 is therefore a complicated surface. However, its outer peripheral portion has a circular shape. With such a dividing surface 26, when the first connecting part 12 is rotated by 180 degrees about the rotation axis 38, no end portion of the first fitting part 20 or the second fitting part 22 facing the dividing surface comes out laterally in the middle of the rotation. This prevents the operator from being injured by any end portion of the first fitting part 20 or the second fitting part 22 coming out therefrom. Further, since the rotary fitting body 18 keeps its spherical shape even in the middle of the rotation, the exterior improves as well.

Referring to FIG. 3B, by the rotation as described above, an angle θ3 at which an axial line 46 of the first connecting part 12 and the axial line of the second connecting part 14 cross each other shifts to a right angle (90 degrees). As a result, the hose to be connected to the first connecting part 12 and the hose to be connected to the third connecting part 16 will bend at a right angle at the position where the fluid fitting 10 is interposed. In this way, the hoses can be routed in a tight space. Thus, the usability is improved for the user who uses a nail gun or the like connected to the hose.

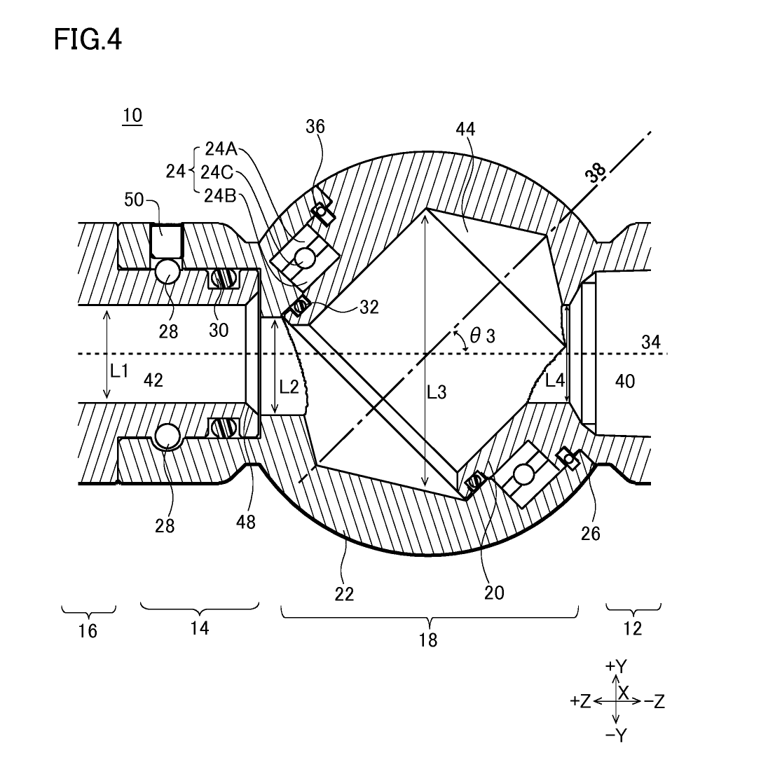

The configuration of the fluid fitting 10 will be described further in detail with reference to FIG. 4. As described above, the bearing 24 is a member disposed between the first fitting part 20 and the second fitting part 22, and configured to smoothen the rotation of these two parts. The bearing 24 is formed of an outer ring 24A, steel balls 24C, and an inner ring 24B in this order from the outer side. The outer ring 24A is made of a metallic member formed in a ring shape, and is joined to the inner peripheral surface of the second fitting part 22 with adhesive or fastening means such as a screw. The inner ring 24B is also made of a metallic member formed in a ring shape, and is joined to the outer peripheral surface of the first fitting part 20 with adhesive or the like. The steel balls 24C are disposed between the outer ring 24A and the inner ring 24B and are disposed rotatably in contact with these two rings. While the fluid fitting 10 is in use, the outer ring 24A can rotate together with the second fitting part 22, and the inner ring 24B can rotate together with the first fitting part 20, and the steel balls 24C can rotate therebetween.

In this embodiment, the inner diameter of each connecting part is set to such a length that the flow of the fluid inside the fluid fitting 10 will not be blocked.

Specifically, a width L3, in the Y direction, of the internal space 44 formed inside the rotary fitting body 18 is set greater than an inner diameter L1 of the third connecting part 16 (second flow path 42) to be inserted in the second connecting part 14. Moreover, the width L3 of the internal space 44 is set greater than a width L4 of an opening of the first fitting part 20 and a width L2 of an opening of the second fitting part 22.

While the fluid fitting 10 is in use, compressed air flows through the first flow path 40, the internal space 44, and the second flow path 42 in this order. Since the internal space 44, which is a middle section of the whole flow path, is made larger than the other sections of the flow path, it is possible to reduce the pressure loss due to the interposition of the fluid fitting 10 in the flow path. In particular, as shown in FIGS. 3A and 3B, in the case of using the fluid fitting 10 with the rotary fitting body 18 rotated to make the axial line 34 of the first connecting part 12 and the axial line 34 of the second connecting part 14 cross each other perpendicularly, the behavior of the compressed fluid in the internal space 44 present between these two parts is important. For instance, if the width of the internal space 44 is set equal to or smaller than the those of the first flow path 40 in the first connecting part 12 and the second flow path 42 in the second connecting part 14, the flow of the compressed fluid in the internal space 44 will be blocked, thus possibly increasing the pressure loss. In view of this, in this embodiment, as shown in FIG. 4, the width L3 of the internal space 44 is set greater than the width L1 of the second flow path 42. For example, the maximum width L3 of the internal space 44 is set at least twice greater than the width L1 of the second flow path 42. In this way, the flow of the compressed air will not be blocked in the internal space 44, and the pressure loss will therefore be reduced.

Further, in this embodiment, the width L2 of the opening communicating with the second flow path 42 is set equal to or greater than the width L1 of the second flow path 42. Specifically, the upper end of the opening of the second fitting part 22 is disposed at a level lower than the upper end of the inner wall of the third connecting part 16, so as to ensure a space for disposing the bearing 24. In this embodiment, since the upper end of the opening is disposed at the lower level as mentioned above, the lower end of the opening is disposed at a level lower than the lower end of the third connecting part 16 so that the opening can ensure a sufficient width. Thus, the opening ensures a sufficient width L2. Accordingly, the flow of the compressed air will not be blocked by the opening.

Likewise the width L4 of the opening of the internal space 44 on the first flow path 40 side may be set equal to or greater than the inner diameter of the plug not shown which is to be connected to the first connecting part 12. This allows for prevention of this opening from blocking the flow of the compressed air.

Further, in this embodiment, a chamfered portion 48 is formed at the end of the portion of the second connecting part 14 connected to the second fitting part 22. With this chamfered portion 48, the inner wall of the second fitting part 22 and the inner wall of the third connecting part 16 are joined without any step therebetween. This allows for further smoothening of the flow of the compressed air.

Meanwhile, locking screws 50 are buried in hole portions in which to put the steel balls 28 configured to connect the second connecting part 14 and the third connecting part 16 to each other rotatably.

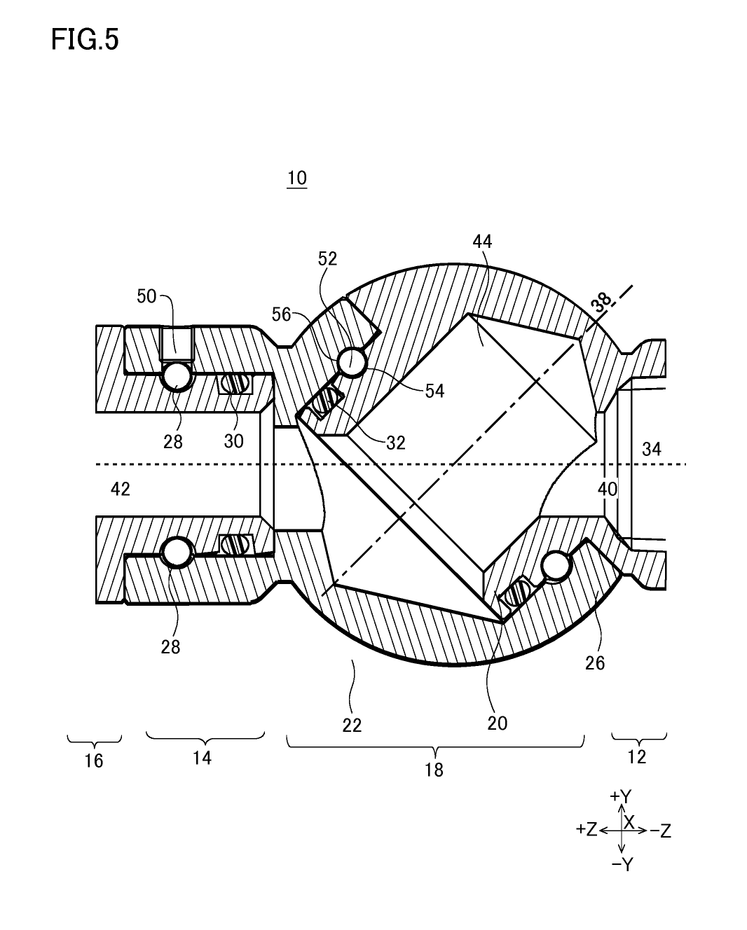

Another embodiment of the above-described fluid fitting 10 will be described with reference to FIG. 5. The basic configuration of a fluid fitting 10 shown in this drawing is the same as that described above with reference to FIG. 4. The difference is that steel balls 52 are provided instead of the bearing 24 described with reference to FIG. 4.

Specifically, a groove 54 is formed in the outer surface of a first fitting part 20 which faces a second fitting part 22. Also, a groove 56 is formed in the inner surface of the second fitting part 22 which faces this groove 54. Moreover, multiple steel balls 52 are disposed in a space surrounded by the groove 54 and the groove 56. When the first fitting part 20 is rotated relative to the second fitting part 22 while the fluid fitting 10 is in use, the steel balls 52 rotate with this rotation. By employing the steel balls 52 instead of the bearing 24 as described above, the configuration of the fluid fitting 10 is simplified as a whole. Thus, the cost can be reduced accordingly.

The fluid fittings of the embodiments described above can be modified as follows, for example.

Referring to FIG. 1B, the fluid fitting 10 can be formed without the third connecting part 16.

Referring to FIG. 4, the steel balls 28 can be disposed inside the rotary fitting body 18 between the first fitting part 20 and the second fitting part 22. With this configuration, the number of components can be reduced as compared to the case where the bearing 24 is disposed between the two parts. Thus, the cost can be reduced.

Referring to FIG. 1B, while the fluid fitting 10 is in use, the fluid flows from the first flow path 40 to the second flow path 42, but the flow may be reversed. The fluid may be caused to flow from the second flow path 42 to the first flow path 40.

Referring to FIG. 1B, the third connecting part 16 is rotatably connected to the second connecting part 14 in the above-described embodiments, but the third connecting part 16 may be rotatably connected to the first connecting part 12.

According to the present invention, the intermedia part of the fluid fitting is formed of the first fitting part and the second fitting part capable of rotating relative to each other, and the dividing surface dividing these two parts is inclined at 45 degrees from the axial direction of the fitting. In this way, hoses connected by the fluid fitting can bend at 90 degrees at the fitting parts. Thus, the workability in a tight space can be improved.

Further, in the present invention, the outer periphery of the dividing surface has a circular shape. In this way, when the first connecting part is rotated, no end portion of the first fitting part or the second fitting part facing the dividing surface comes out laterally in the middle of the rotation. Thus, the operator is prevented from being injured by any portion of the first fitting part or the like coming out therefrom.

What is claimed is:

1. A fluid fitting to be rotatably interposed between paths for connecting a fluid supply source and a fluid using device, comprising:
a first connecting part disposed in such a way as to communicate with one of the fluid supply source and the fluid using device;
a second connecting part disposed in such a way as to communicate with the other of the fluid supply source and the fluid using device; and
a rotary fitting body disposed between the first connecting part and the second connecting part and configured to rotate, wherein
the rotary fitting body includes a first fitting part and a second fitting part rotatably joined to the first fitting part,
a dividing surface by which the first fitting part and the second fitting part are divided is inclined from an axial direction of the first fitting part and the second fitting part, and
an outer periphery of the dividing surface has a circular shape.

2. The fluid fitting according to claim 1, wherein a bearing is disposed between the first fitting part and the second fitting part.

3. The fluid fitting according to claim 1, further comprising a third connecting part rotatably connected to one of the first connecting part and the second connecting part.

4. The fluid fitting according to claim 3, wherein a width of an opening of a portion of any one of the first connecting part and the second connecting part connected to the third connecting part is equal to or greater than an inner diameter of the third connecting part.

5. The fluid fitting according to claim 1, wherein a width of an internal space provided inside the rotary fitting body is greater than a width of an opening of the first fitting part and a width of an opening of the second fitting part.

6. The fluid fitting according to claim 1, wherein
the first connecting part and the first fitting part are formed integrally from a metallic material, and
the second connecting part and the second fitting part are formed integrally from a metallic material.

7. The fluid fitting according to claim 1, wherein the dividing surface is inclined at 45 degrees from the axial direction.
